(19) United States
(12) Patent Application Publication
(10) Pub. No.: US 2023/0138467 A1
(43) Pub. Date: May 4, 2023

(54) Multi-Purpose Scoop Device

(71) Applicant: Roberto Coronel, Union City, CA (US)

(72) Inventor: Roberto Coronel, Union City, CA (US)

(21) Appl. No.: 18/050,667

(22) Filed: Oct. 28, 2022

Related U.S. Application Data
(60) Provisional application No. 63/273,236, filed on Oct. 29, 2021.

(51) Int. Cl. G01F 11/26; G01F 19/00

(52) U.S. Cl. CPC G01F 11/26; G01F 19/002; B67C 2011/40

(57) ABSTRACT

The present invention relates to a novel multipurpose scoop device. The device is a scoop for water soluble powders, such as protein powders, baby formula powders, etc. The device comprises a scooping portion component with a holding cavity disposed at one end of the scoop device and a funnel component disposed at an opposing end of the scoop device. The scoop device attaches to the top of the lid of a powder container and a user rotates the scoop device to open the powder container and the holding cavity of the device. The user then inverts the powder container to fill the scoop device and rotates the scoop device again to close off the powder container. The user then removes the scoop device filled with powder from the powder container for use.

### CROSS-REFERENCE TO RELATED APPLICATION

The present application claims priority to, and the benefit of, U.S. Provisional Application No. 63/273,236, which was filed on Oct. 29, 2021, and is incorporated herein by reference in its entirety.

### FIELD OF THE INVENTION

The present invention relates generally to the field of multipurpose scoop devices. More specifically, the present invention relates to an improved multipurpose scoop device that provides users with a multipurpose scoop for formula powders, fitness powders, etc. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in multipurpose scoop devices. Generally, a scoop is any specialized holding device or container used to serve a food substance. As it relates to powder substances, i.e., protein powder, baby formula, etc., it can be very difficult and time-consuming to manipulate, contain, and pour the powder. These challenges are exacerbated with very fine powder substances and when pouring the powder substances into a container with a narrow neck or opening on the container, i.e., a water bottle.

Further, using different scoopers to pour powdered items into various containers can lead to cross-contamination. In some instances, powdered and liquid formula that is mixed, especially for young children and infants can be dangerous.

Additionally, when mixing a powder or granular material with a liquid, it is common to use a measuring cup to scoop the material and pour it into a container of water. However, when pouring powder into a container having a relatively small opening, such as a water bottle, it is difficult to pour the powder into the opening of the container without spilling some of the powder. Therefore, there is a need for devices that make the process of pouring powdered material into a container easier and cleaner.

To address some of the above-referenced challenges, the disclosed multipurpose scoop device includes an incorporated funnel. The multipurpose scoop device includes a scooping portion with a holding cavity disposed at one end of the scoop device and a funnel, defining a funnel channel, disposed at an opposing end of the scoop device.

Therefore, there exists a long-felt need in the art for a multipurpose scoop device that provides users with a multipurpose scoop for formula powders, fitness powders, etc. There is also a long-felt need in the art for a multipurpose scoop device that allows the scoop to attach directly to the lid of a powdered container, eliminating the need for a handheld and independent scoop. Further, there is a long-felt need in the art for a multipurpose scoop device that enables users to rotate the scoop to open the container, invert the container to fill the scoop, and then rotate it once more to close off the container. Moreover, there is a long-felt need in the art for a device that keeps scoops associated with a single container to prevent cross-contamination. Further, there is a long-felt need in the art for a multipurpose scoop device that includes a travel cap for convenient transportation. Finally, there is a long-felt need in the art for a multipurpose scoop device that provides users with a device that makes the process of pouring powdered material into a container easier and cleaner.

The subject matter disclosed and claimed herein, in one embodiment thereof, comprises a multipurpose scoop device. The device is a scoop for water soluble powders, such as protein powders, baby formula powders, etc. The device comprises a scooping portion component with a holding cavity disposed at one end of the scoop device and a funnel component disposed at an opposing end of the scoop device. The scoop device attaches to the top of the lid of a powder container by squeezing or snapping, i.e., press-fit feature, on the device. Further, the device would have a round bevel ring and/or a snap on an attachment located on the funnel component of the device to secure the funnel component when not in use. The opposing end with the scooping portion component and the lid of the powder container would both have a pull and/or a knockout section for opening and closing. Thus, the scoop device attaches to the top of the lid of the powder container and a user rotates the scoop device to open the powder container and the holding cavity of the device. The user then inverts the powder container to fill the scoop device and rotates the scoop device again to close off the powder container. The user then removes the scoop device filled with powder from the powder container for use. Further, the scoop device comprises a screw-on and/or snap on travel cap to facilitate simple and convenient transportation.

In this manner, the multipurpose scoop device of the present invention accomplishes all of the foregoing objectives and provides users with a device that that make the process of pouring powdered material into a container easier and cleaner. The device provides users with a convenient way to utilize water soluble powders, such as protein powders, baby formula, etc. The device can be manufactured of specific materials that are used for safety and to prevent contamination.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose scoop device. The device comprises a scooping portion component with a holding cavity disposed at one end of the scoop device and a funnel component disposed at an opposing end of the scoop device. The scoop device attaches to the top of the lid of the powder container and a user rotates the scoop device to open the powder container and the holding cavity of the device. The user then inverts the powder container to fill the scoop device and rotates the scoop device again to close off the powder container. The user then removes the scoop device filled with powder from the powder container for use.

The multipurpose scoop device is a scoop for water soluble powders, such as protein powders, baby formula powders, etc. The multipurpose scoop device described above can be used to scoop and pour any desired material, for example, fitness supplements, baby formula, bird seed, kitchen supplies such as sugar and flour, etc. The scoop device can also be used as a measuring device, where a user can easily scoop and pour a desired amount of material. Further, the scoop device described can also be configured to hold any desired volume of material.

Accordingly, the present invention provides a novel and efficient multipurpose scoop device that effectively and efficiently scoops, i.e., receives, a powder substance, while simultaneously being operable to pour or dispense the powder substance without any inadvertent spillage of the powder substance. While having particular and unique benefits associated with retaining and dispensing a fine powder substance, the scoop device may also be beneficial for other food or powdery substances as is known in the art.

In one embodiment, the multipurpose scoop device comprises a scooping portion component with a holding cavity component disposed at one end of the scoop device and a funnel component disposed at an opposing end of the scoop device. More specifically, the multipurpose scoop device may be formed from a single piece of material, i.e., through a casting or blow-molding process, while in other embodiments the components may be individually formed and joined or coupled together, i.e., using fastener(s), adhesive, sonic welding, etc. The multipurpose scoop device is typically manufactured from a polymeric material, such as polypropylene, a ceramic material, a metallic material, or a combination of the same. The components are preferably substantially rigid. Further, the components may be constructed of light transmitting material, preferably transparent, or at least a translucent material, such that a user can see the contents of the multipurpose scoop device and measure the amount of powder dispensed.

In one embodiment, the scooping portion component of the device includes a bottom wall and a sidewall surrounding the bottom wall. Both the bottom wall and the sidewall, namely the inner surfaces thereon, define a scooping cavity, i.e., the scooping portion component of the device. Generally, the inner surfaces defining the scooping cavity form a hemi-spherical-shaped cavity that effectively enables movement and measuring of the powder substance when retained therein. However, the shape of the scooping cavity can take any desired form, as long as the configuration of the scooping portion component allows a user to use the device to scoop and hold a powered material. Further, the inner surfaces defining the scooping cavity may also be smooth and preferably have a low coefficient of friction, i.e., less than approximately 0.5. As used herein, the term “wall” is intended broadly to encompass continuous structures, as well as separate structures that are coupled together to form a substantially continuous external surface.

In one embodiment, the sidewall may also define a funnel entrance to the funnel component. The funnel entrance is defined on the sidewall to effectively transport and dispense the powdery substance housed in the scooping cavity. Additionally, the funnel entrance may be defined by a curved and tapering inner surface perimeter of the sidewall. The curved and tapering inner surface perimeter facilitates in directing all of the retained powdery substance into the funnel entrance and through the funnel component of the device and, ultimately, out of the device.

In one embodiment, the maximum outer diameter or width of the funnel component is approximately two inches in order to effectively enter an opening on a bottle container opening, i.e., the distal opening on a water bottle, etc. In another embodiment, the outer surface of the funnel component may include a flanged funnel member. The flanged funnel member may serve at least two purposes. First, the flanged funnel member may be of a deformably resilient material, i.e., natural rubber, which is operably configured to seal the funnel component with respect to the bottle container to which the powder is being dispensed. Additionally, the flanged funnel member may act as a stop for preventing the funnel component from entering the bottle container opening after a particular distance, i.e., approximately one inch.

In one embodiment, the multipurpose scoop device comprises a handle portion extending outwardly away from the outer surface of the sidewall in a substantially perpendicular orientation. Thus, the scoop device is advantageously configured with the handle portion in an orientation enabling the user to scoop the powdery substance and level the scoop device. The handle portion can be of any suitable shape and size for handling and manipulation by the user. The handle portion has an optional hole formed to allow the device to hang from a hook, nail, etc.

In one embodiment, the scooping cavity or scooping portion component may hold approximately 60-90 cc of powder. In other embodiments, the volume or capacity of the scooping cavity may vary outside of the ranges. Further, to facilitate in measuring the amount of powder to be dispensed, the outer surface of the sidewall includes a plurality of measurement indicia disposed thereon and located on an opposing side of the sidewall. The measurement indicia may be demarcation lines with corresponding values indicating the volume value for each demarcation line, or any other suitable measurement indicia as is known in the art.

In one embodiment, the distal end of the funnel component comprises a round bevel ring and/or a snap on lid component with holding strap, whereby the snap on lid component completely seals the funnel component and prevents the powder from dispensing when not in use.

In one embodiment, the distal end of the holding cavity component of the device is secured to the top of the lid of a powder container by squeezing or snapping, i.e., a press-fit feature, or by any other suitable securing means as is known in the art.

In another embodiment, the holding cavity component or the lid of the powder container would have a pull, a cutout, and/or a knockout section for opening and closing. In another embodiment, the holding cavity component and the lid of the powder container would both have a pull, a cutout, and/or a knockout section for opening and closing. Specifically, the cutout or knockout section refers to a design element where the paperboard or plastic lid is cutout (or knocked out/removed) to allow access to the contents of the powder container. This cutout or knockout allows the holding cavity component and the powder container lid to have an open position and a closed position. When the powder container is in the open position, the scoop device can be used to transfer powder material from the powder container to the device. Once transferred, the powder container lid can be moved to the closed position and the powder locked in place within the device. The device can then be placed on top of a bottle container, to pour the powder material into the bottle container.

Accordingly, the multipurpose scoop device is secured to a powder container lid. The user then rotates the scoop device to open the knockout section of the powder container lid and/or the holding cavity component of the scoop device to allow access to the scooping cavity. Once in an open position, the user inverts the powder container to fill the scoop device. Once filled to a desired level, the user rotates the scoop device to close-off the powder container lid and/or the holding cavity component of the scoop device, which prevents access to the scooping cavity. The user then removes the scoop device from the powder container for use. In the closed position, the powder material is enclosed within the scoop device until the user opens the funnel component to pour the powder material into a bottle container.

In another embodiment, the multipurpose scoop device comprises a screw-on and/or snap on travel cap which would seal the holding cavity component to facilitate transportation of the device without spilling the powder retained within the device.

In yet another embodiment, the multipurpose scoop device comprises a plurality of indicia.

In yet another embodiment, a method of pouring powdered material into a container without making a mess is disclosed. The method includes the steps of securing a multipurpose scoop device to a lid of a powder container. The method also comprises rotating the scoop device to open the powder container. Further, the method comprises inverting the scoop device to fill the scoop device with powder from the powder container. The method includes the steps of rotating the scoop device closed and removing the scoop device from the powder container. Finally, pouring the powder into a bottle component from the scoop device without making a mess.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the multipurpose scoop device of the present invention secured to a powder container in accordance with the disclosed architecture;

FIGS. 2A-B illustrate a perspective view of one embodiment of the multipurpose scoop device of the present invention showing how the scoop device can be rotated open and closed in accordance with the disclosed architecture;

FIG. 3 illustrates a perspective view of one embodiment of the multipurpose scoop device of the present invention dispensing powder through the funnel component in accordance with the disclosed architecture; and

FIG. 4 illustrates a flowchart showing the method of pouring powdered material into a container without making a mess in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a multipurpose scoop device that provides users with a multipurpose scoop for formula powders, fitness powders, etc. There is also a long-felt need in the art for a multipurpose scoop device that allows the scoop to attach directly to the lid of a powdered container, eliminating the need for a handheld and independent scoop. Further, there is a long-felt need in the art for a multipurpose scoop device that enables users to rotate the scoop to open the container, invert the container to fill the scoop, and then rotate it once more to close off the container. Moreover, there is a long-felt need in the art for a device that keeps scoops associated with a single container to prevent cross-contamination. Further, there is a long-felt need in the art for a multipurpose scoop device that includes a travel cap for convenient transportation. Finally, there is a long-felt need in the art for a multipurpose scoop device that provides users with a device that makes the process of pouring powdered material into a container easier and cleaner.

The present invention, in one exemplary embodiment, is a novel multipurpose scoop device. The device is a scoop for water soluble powders, such as protein powders, baby formula powders, etc. The device comprises a scooping portion component with a holding cavity disposed at one end of the scoop device and a funnel component disposed at an opposing end of the scoop device. The scoop device attaches to the top of the lid of a powder container and a user rotates the scoop device to open the powder container and the holding cavity of the device. The user then inverts the powder container to fill the scoop device and rotates the scoop device again to close off the powder container. The user then removes the scoop device filled with powder from the powder container for use. The present invention also includes a novel method of pouring powdered material into a container without making a mess. The method includes the steps of securing a multipurpose scoop device to a lid of a powder container. The method also comprises rotating the scoop device to open the powder container. Further, the method comprises inverting the scoop device to fill the scoop device with powder from the powder container. The method includes the steps of rotating the scoop device closed and removing the scoop device from the powder container. Finally, pouring the powder into a bottle component from the scoop device without making a mess.

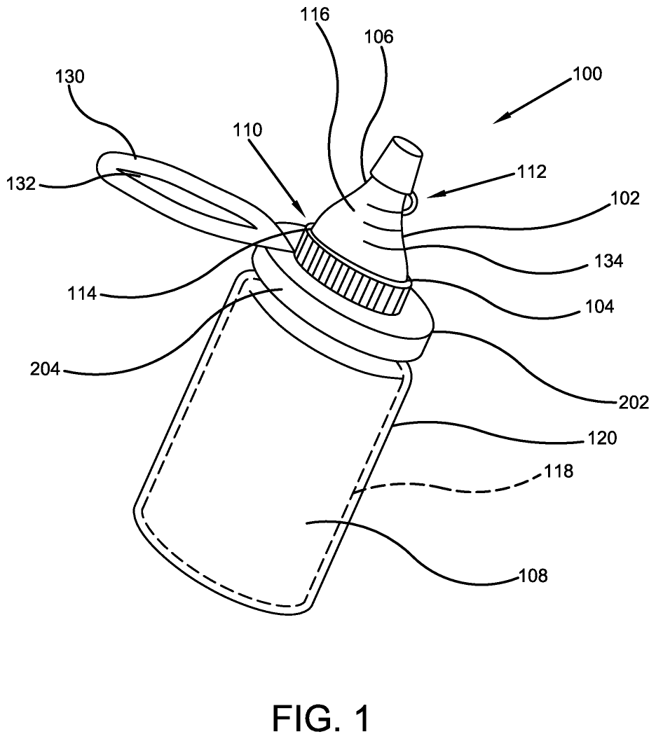

Referring initially to the drawings, FIG. 1 illustrates a perspective view of one embodiment of the multipurpose scoop device 100 of the present invention. In the present embodiment, the multipurpose scoop device 100 is an improved scoop device 100 that can be utilized to prevent cross-contamination of water-soluble powders. Specifically, the device 100 is an improved multipurpose scoop device. The multipurpose scoop device 100 comprises a scooping portion component 102 with a holding cavity component 104 disposed at one end of the scoop device 100 and a funnel component 106 disposed at an opposing end of the scoop device 100. Users secure the scoop device 100 to a powder container 108 and a user rotates the scoop device 100 to open the powder container 108. A user then inverts the device 100 to fill and then rotates the device 100 to close-off the powder container 108. The user then removes the scoop device 100 filled with powder from the powder container 108 for use.

Specifically, the multipurpose scoop device 100 is a scoop for water soluble powders, such as protein powders, baby formula powders, etc., or any other suitable powders as is known in the art, depending on the needs and/or wants of a user. The multipurpose scoop device 100 described above can be used to scoop and pour any desired material, for example, fitness supplements, baby formula, bird seed, kitchen supplies such as sugar and flour, etc. The scoop device 100 can also be used as a measuring device, where a user can easily scoop and pour a desired amount of material. Further, the scoop device 100 described can also be configured to hold any desired volume of material.

Accordingly, the present invention provides a novel and efficient multipurpose scoop device 100 that effectively and efficiently scoops, i.e., receives, a powder substance, while simultaneously being operable to pour or dispense the powder substance without any inadvertent spillage of the powder substance. While having particular and unique benefits associated with retaining and dispensing a fine powder substance, the scoop device 100 may also be beneficial for other food or powdery substances as is known in the art.

The multipurpose scoop device 100 comprises a scooping portion component 102 with a holding cavity component 104 disposed at one end (first end 110) of the scoop device 100 and a funnel component 106 disposed at an opposing end (second end 112) of the scoop device 100. More specifically, the multipurpose scoop device 100 may be formed from a single piece of material, i.e., through a casting or blow-molding process, while in other embodiments the components may be individually formed and joined or coupled together, i.e., using fastener(s), adhesive, sonic welding, etc. The multipurpose scoop device 100 is typically manufactured from a polymeric material, such as polypropylene, a ceramic material, a metallic material, or a combination of the same. The components are preferably substantially rigid. Further, the components may be constructed of light transmitting material, preferably transparent, or at least a translucent material, such that a user can see the contents of the multipurpose scoop device 100 and measure the amount of powder dispensed. One skilled in the art will understand that any suitable material possessing an appropriate amount of flexibility and resiliency may be used to manufacture the multipurpose scoop device 100. Additionally, the multipurpose scoop device 100 can also be manufactured from a material that is water resistant or waterproof, or comprises a coating that is water resistant or waterproof.

Further, the scooping portion component 102 of the device 100 includes a bottom wall 114 and a sidewall 116 surrounding the bottom wall 114. Both the bottom wall 114 and the sidewall 116, namely the inner surfaces 118 thereon, define a scooping cavity, i.e., the scooping portion component 102 of the device 100. Generally, the inner surfaces 118 defining the scooping cavity 102 form a hemi-spherical-shaped cavity that effectively enables movement and measuring of the powder substance when retained therein. However, the shape of the scooping cavity 102 can take any desired form, as long as the configuration of the scooping portion component 102 allows a user to use the device 100 to acquire and hold a powered material. Further, the inner surfaces 118 defining the scooping cavity 102 may also be smooth and preferably have a low coefficient of friction, i.e., less than approximately 0.5. As used herein, the term “wall” is intended broadly to encompass continuous structures, as well as separate structures that are coupled together to form a substantially continuous external surface.

Additionally, the sidewall 116 may also define a funnel entrance 122 to the funnel component 106. The funnel entrance 122 is defined on the sidewall 116 to effectively transport and dispense the powdery substance housed in the scooping cavity 102. Additionally, the funnel entrance 122 may be defined by a curved and tapering inner surface 118 perimeter of the sidewall 116. The curved and tapering inner surface 118 perimeter facilitates in directing all of the retained powdery substance into the funnel entrance 122 and through the funnel component 106 of the device 100 and, ultimately, out of the device 100.

In one embodiment, the maximum outer diameter or width 124 of the funnel component 106 is approximately two inches in order to effectively enter an opening on a bottle container opening 300, i.e., the distal opening 300 on a water bottle 302, etc. In another embodiment, the outer surface 126 of the funnel component 106 may include a flanged funnel member 128. The flanged funnel member 128 may serve at least two purposes. First, the flanged funnel member 128 may be of a deformably resilient material, i.e., natural rubber, which is operably configured to seal the funnel component 106 with respect to the bottle container 302 to which the powder is being dispensed. Additionally, the flanged funnel member 128 may act as a stop for preventing the funnel component 106 from entering the bottle container opening 300 after a particular distance, i.e., approximately one inch.

In another embodiment, the multipurpose scoop device 100 comprises a handle portion 130 extending outwardly away from the outer surface 120 of the sidewall 116 in a substantially perpendicular orientation. Thus, the scoop device 100 is advantageously configured with the handle portion 130 in an orientation enabling the user to scoop the powdery substance and level the scoop device 100. The handle portion 130 can be of any suitable shape and size for handling and manipulation by the user. The handle portion 130 has an optional hole 132 formed to allow the device 100 to hang from a hook, nail, etc.

Generally, the scooping cavity or scooping portion component 102 may hold approximately 60-90 cc of powder. In other embodiments, the volume or capacity of the scooping cavity 102 may vary outside of the ranges. Further, to facilitate in measuring the amount of powder to be dispensed, the outer surface 120 of the sidewall 116 includes a plurality of measurement indicia 134 disposed thereon and located on an opposing side of the sidewall 116. The measurement indicia 134 may be demarcation lines with corresponding values indicating the volume value for each demarcation line, or any other suitable measurement indicia as is known in the art.

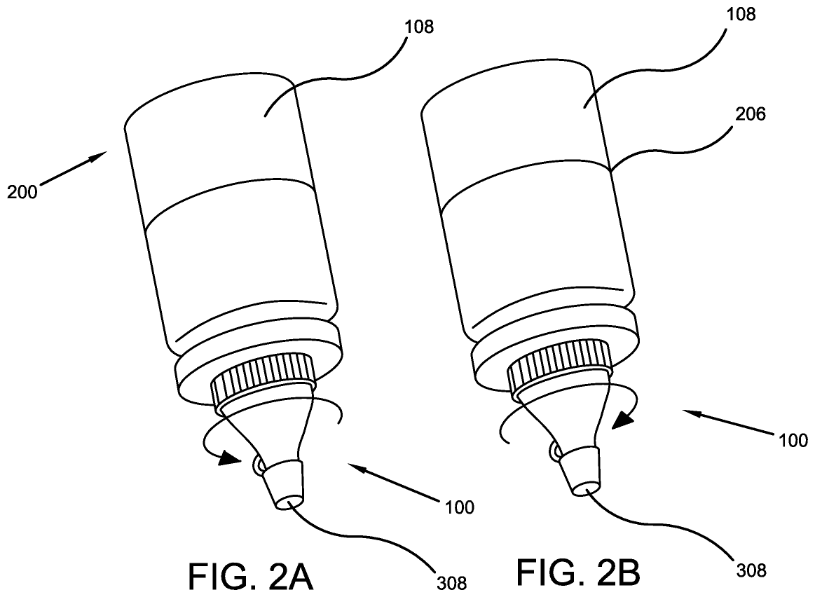

As shown in FIGS. 2A-B, the distal end 200 of the holding cavity component 104 of the device 100 is secured to the top 202 of the lid 204 of a powder container 108 via by squeezing or snapping, i.e., a press-fit feature, or by any other suitable securing means as is known in the art, depending on the needs and/or wants of a user.

Furthermore, the holding cavity component 104 or the lid 202 of the powder container 108 would have a pull, a cutout, and/or a knockout section 206 for opening and closing. In another embodiment, the holding cavity component 104 and the lid 202 of the powder container 108 would both have a pull, a cutout, and/or a knockout section 206 for opening and closing. Specifically, the cutout or knockout section 206 refers to a design element where the paperboard or plastic lid 202 is cutout (or knocked out/removed) to allow access to the contents of the powder container 108. This cutout or knockout section 206 allows the holding cavity component 104 and the powder container lid 202 to have an open position and a closed position. When the powder container 108 is in the open position, the scoop device 100 can be used to transfer powder material from the powder container 108 to the device 100. Once transferred, the powder container lid 202 can be moved to the closed position and the powder locked in place within the device 100. The device 100 can then be placed on top of a bottle container opening 300, to pour the powder material into the bottle container 302.

Accordingly, the multipurpose scoop device 100 is secured to a powder container lid 202. The user then rotates the scoop device 100 to open the knockout section 206 of the powder container lid 202 and/or the holding cavity component 104 of the scoop device 100 to allow access to the scooping cavity 102. Once in an open position, the user inverts the powder container 108 to fill the scoop device 100. Once filled to a desired level, the user rotates the scoop device 100 to close-off the powder container lid 202 and/or the holding cavity component 104 of the scoop device 100, which prevents access to the scooping cavity 102. The user then removes the scoop device 100 from the powder container 108 for use. In the closed position, the powder material is enclosed within the scoop device 100 until the user opens the funnel component 106 to pour the powder material into a bottle container 302.

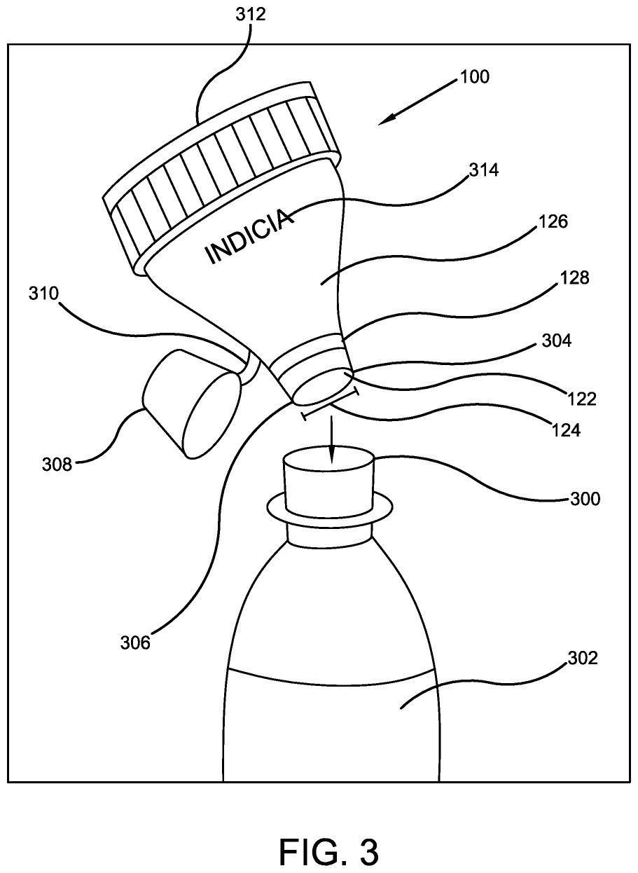

As shown in FIG. 3, the distal end 304 of the funnel component 106 comprises a round bevel ring 306 and/or a snap on lid component 308 with holding strap 310, whereby the snap on lid component 308 completely seals the funnel component 106 and prevents the powder from dispensing when not in use. Further, the funnel component 106 can comprise any other suitable lid device as is known in the art, depending on the needs and/or wants of a user.

Further, the multipurpose scoop device 100 comprises a screw-on and/or snap on travel cap 312 which would seal the holding cavity component 104 to facilitate transportation of the device 100 without spilling the powder retained within the device 100. The travel cap 312 can be any suitable size and shape as is known in the art, as long as the travel cap 312 acts to retain the powder within the device 100.

In yet another embodiment, the multipurpose scoop device 100 comprises a plurality of indicia 314. The scooping portion component 102 of the device 100 may include advertising, a trademark, or other letters, designs, or characters, printed, painted, stamped, or integrated into the scooping portion component 102, or any other indicia 314 as is known in the art. Specifically, any suitable indicia 314 as is known in the art can be included, such as, but not limited to, patterns, logos, emblems, images, symbols, designs, letters, words, characters, animals, advertisements, brands, etc., that may or may not be product or brand related.

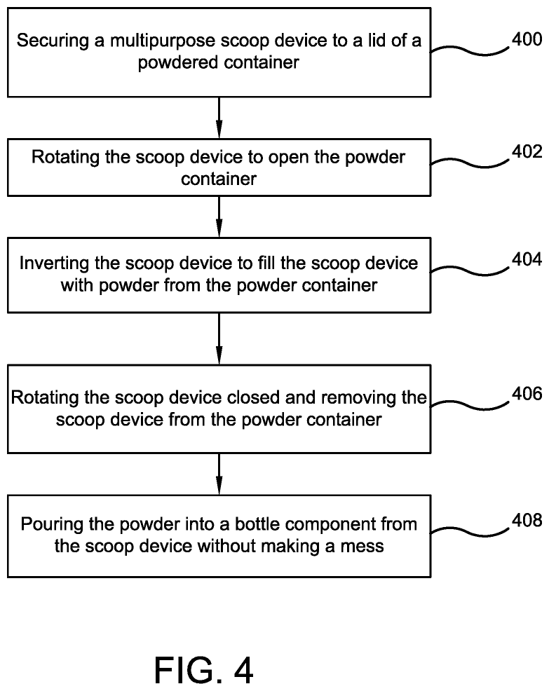

FIG. 4 illustrates a flowchart of the method of pouring powdered material into a container without making a mess. The method includes the steps of at 400, securing a multipurpose scoop device to a lid of a powder container. The method also comprises at 402, rotating the scoop device to open the powder container. Further, the method comprises at 404, inverting the scoop device to fill the scoop device with powder from the powder container. The method includes the steps of at 406, rotating the scoop device closed and removing the scoop device from the powder container. Finally, at 408, pouring the powder into a bottle component from the scoop device without making a mess.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “multipurpose scoop device”, “scoop device”, and “device” are interchangeable and refer to the multipurpose scoop device 100 of the present invention.

Notwithstanding the foregoing, the multipurpose scoop device 100 of the present invention can be of any suitable size and configuration as is known in the art without affecting the overall concept of the invention, provided that it accomplishes the above-stated objectives. One of ordinary skill in the art will appreciate that the multipurpose scoop device 100 as shown in FIGS. 1-4 are for illustrative purposes only, and that many other sizes and shapes of the multipurpose scoop device 100 are well within the scope of the present disclosure. Although the dimensions of the multipurpose scoop device 100 are important design parameters for user convenience, the multipurpose scoop device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multipurpose scoop device that can be utilized to prevent cross-contamination of water-soluble powders, the multipurpose scoop device comprising:
a scooping portion component;
a holding cavity component; and
a funnel component;
wherein the scooping portion component comprises the holding cavity component disposed at one end and the funnel component disposed at an opposing end of the scooping portion component;
wherein a user secures the holding cavity component to a powder container and inverts the multipurpose scoop device to fill the scooping portion component with powder and then removes the multipurpose scoop device from the powder container; and
further wherein the scooping portion component is filled with powder from the powder container for use.

2. The multipurpose scoop device of claim 1, wherein the multipurpose scoop device is used for water soluble powders, such as protein powders and baby formula powders.

3. The multipurpose scoop device of claim 2, wherein the multipurpose scoop device is constructed of light transmitting material, such that a user can see contents of the multipurpose scoop device.

4. The multipurpose scoop device of claim 3, wherein the scooping portion component comprises a bottom wall and a sidewall surrounding the bottom wall, wherein both the bottom wall and the sidewall define a cavity.

5. The multipurpose scoop device of claim 4, wherein the sidewall defines a funnel entrance to the funnel component.

6. The multipurpose scoop device of claim 5, wherein an outer surface of the funnel component includes a flanged funnel member.

7. The multipurpose scoop device of claim 6 further comprising a handle portion extending outwardly from the sidewall.

8. The multipurpose scoop device of claim 7, wherein the sidewall comprises a plurality of measurement indicia.

9. The multipurpose scoop device of claim 8, wherein the holding cavity component is secured to a powder container lid via a press-fit feature.

10. The multipurpose scoop device of claim 9, wherein holding cavity component or the powder container lid comprises a knockout section for opening and closing.

11. The multipurpose scoop device of claim 10, wherein a distal end of the funnel component comprises a round bevel ring and a snap on lid component with a holding strap to seal the funnel component and prevent powder from dispensing when not in use.

12. The multipurpose scoop device of claim 11 further comprising a screw-on travel cap which would seal the holding cavity component to facilitate transportation without spilling the powder.

13. The multipurpose scoop device of claim 12 further comprising a plurality of indicia.

14. A multipurpose scoop device that can be utilized to prevent cross-contamination of water-soluble powders, the multipurpose scoop device comprising:
a scooping portion component;
a holding cavity component; and
a funnel component;
wherein the scooping portion component comprises the holding cavity component disposed at one end and the funnel component disposed at an opposing end of the scooping portion component;
wherein the holding cavity component or the powder container lid comprises a knockout section for opening and closing;
wherein a user secures the holding cavity component to a powder container via a press-fit feature;
wherein a user then rotates the multipurpose scoop device to open the knockout section to allow access to the scooping portion component;
wherein a user inverts the powder container to fill the multipurpose scoop device and then rotates the multipurpose scoop device to close-off the powder container; and
further wherein the user removes the multipurpose scoop device filled with powder from the powder container for use.

15. The multipurpose scoop device of claim 14, wherein a distal end of the funnel component comprises a round bevel ring and a snap on lid component with a holding strap to seal the funnel component and prevent powder from dispensing when not in use.

16. The multipurpose scoop device of claim 14 further comprising a screw-on travel cap which would seal the holding cavity component to facilitate transportation without spilling the powder.

17. The multipurpose scoop device of claim 14, wherein the sidewall comprises a plurality of measurement indicia.

18. The multipurpose scoop device of claim 17, wherein the multipurpose scoop device is constructed of light transmitting material, such that a user can see contents of the multipurpose scoop device.

19. The multipurpose scoop device of claim 14, wherein the scooping portion component comprises a bottom wall and a sidewall surrounding the bottom wall, wherein both the bottom wall and the sidewall define a cavity, and wherein the sidewall defines a funnel entrance to the funnel component.

20. A method of pouring powdered material into a container without making a mess, the method comprising the steps of:
securing a multipurpose scoop device to a lid of a powder container;
rotating the scoop device to open the powder container;
inverting the scoop device to fill the scoop device with powder from the powder container;
rotating the scoop device closed and removing the scoop device from the powder container; and
pouring the powder into a bottle component from the scoop device without making a mess.
